(19) United States
(12) Patent Application Publication
(10) Pub. No.: US 2026/0028966 A1
(43) Pub. Date: Jan. 29, 2026

(54) SERVICE UNIT WITH CRANE FOR MODULAR NACELLE OF A WIND TURBINE AND METHOD OF USING SAME

(71) Applicant: Vestas Wind Systems A/S, Aarhus N. (DK)

(72) Inventor: Joris Kofman, Aalborg Øst (DK)

(73) Assignee: Vestas Wind Systems A/S, Aarhus N. (DK)

(21) Appl. No.: 18/994,251

(22) PCT Filed: Jun. 28, 2023
(86) PCT No.: PCT/DK2023/050170

§ 371 Date: Jan. 14, 2025

(30) Foreign Application Priority Data
Jul. 21, 2022 (DK) PA202200707

(51) Int. Cl. F03D 80/50; B66C 23/20; F03D 13/10

(52) U.S. Cl. CPC F03D 80/50; B66C 23/207; F03D 13/139; F05B 2230/61

(57) ABSTRACT

A service unit (24) for a wind turbine (10) nacelle (14) that includes a main nacelle unit (22) having a main housing outer wall (72) and a base frame (98) with a mounting pad (100). The base frame (98) is configured to be attached to a tower (12) of the wind turbine (10). The service unit (24) includes a frame (38) that extends between a first end (40) and a second end (42) to define a longitudinal axis (A2) of the service unit (24), and sidewalls (44, 44a, 44b) that define an interior (50). A crane (26) is located within the interior (50) of the service unit (24) and includes a crane base (62) with a mounting interface (68) configured to be connected to the mounting pad (100) to couple the crane (26) to the base frame (98) of the main nacelle unit (22). The crane base (62) is rotatably movable between a stored position where the mounting interface (68) is positioned within the interior (50) of the service unit (24), and a deployed position where the mounting interface (68) extends through one of the sidewalls (44a, 44b) of the service unit (24). A method of erecting or servicing a wind turbine using the service unit (24) is also disclosed.

### TECHNICAL FIELD

This invention relates generally to wind turbines, and more particularly to a service unit housing a crane for use with a modular nacelle of a wind turbine, and to a method of erecting or servicing a wind turbine using the service unit.

### BACKGROUND

Wind turbines are used to produce electrical energy using a renewable resource and without combusting a fossil fuel. Generally, a wind turbine converts kinetic energy from the wind into electrical power. A horizontal-axis wind turbine includes a tower, a nacelle located at the apex of the tower, and a rotor having a plurality of blades and supported in the nacelle by means of a shaft. The shaft couples the rotor either directly or indirectly with a generator, which is housed inside the nacelle. Consequently, as wind forces the blades to rotate, electrical energy is produced by the generator. Wind turbines may be located either on a land mass (onshore) or within a body of water (offshore).

As electrical energy demands have increased over the past years, the size of wind turbines have also increased so that they may produce additional electrical energy. As the wind turbines increase in size, the physical dimensions and weight of the wind turbine components also increase. As the size and weight of the wind turbine components increase, installing the components to the wind turbine becomes more challenging. To meet this challenge, the nacelle of a wind turbine may be constructed from one or more modules that contain one or more wind turbine components. A service unit module that contains a crane may also be attached to the nacelle to perform installation and/or maintenance activities on the wind turbine. To this end, the lifting capacity of the crane must also be increased to handle larger wind turbine components for installation and maintenance activities, resulting in a larger size and weight of the crane.

Preferably, the service unit is formed with a size and shape comparable to the size and shape of a shipping freight container so that the cost advantages of shipping freight containers with respect to handling, transportation, and storage can be realized. To this end, shipping freight containers can be handled anywhere in the world by ship, train, and truck, for example, at lower costs compared to bulk transport. As a result, the service units can be efficiently shipped to a wind turbine installation site where they may then be lifted and temporarily attached to the sides of the main nacelle unit at the top of the tower using, for example, a suitable crane. Once attached to the main nacelle unit, the crane may be deployed for installation and/or maintenance activities on the wind turbine.

However, as the size and the weight of cranes are increased to handle larger wind turbine components, it remains important that the crane fit within the confines of a service unit having dimensions similar to that of a shipping freight container for the reasons described above. Therefore, a need exists for a crane with increased lifting capacity, such as up to 38,000 kg or more, resulting in an increased size and weight of the crane, that fits within the confines of a service unit having dimensions similar to a freight shipping container, and a method for deploying and attaching the crane to the main nacelle unit.

### SUMMARY

In a first aspect of the invention, a service unit for a wind turbine nacelle is disclosed. The wind turbine nacelle includes a main unit having a main housing outer wall and a base frame with a mounting pad, the base frame configured to be attached to a tower of the wind turbine. The service unit includes a frame extending between a first end and an opposite second end to define a longitudinal axis of the service unit and further includes sidewalls which define an interior of the service unit. A crane is located within the interior of the service unit and includes a crane base with a mounting interface configured to be connected to the mounting pad of the base frame to thereby couple the crane to the base frame of the nacelle. The crane base is rotatably movable between a stored position and a deployed position. In the stored position, the mounting interface is positioned within the interior of the service unit, and in the deployed position, the mounting interface extends through one of the sidewalls of the service unit for connection to the mounting pad of the base frame in the main unit. The engagement between the crane in the service unit and the base frame in the main unit provides a load path, such as a direct load path, from the crane to the primary load bearing part (i.e., the base frame) of the nacelle. This avoids large loads from the crane being transferred to the base frame via the housings of the service unit and the main unit.

In one embodiment, the crane base may be further movable in two directions of motion relative to the longitudinal axis of the service unit in order to move the crane base between the stored position and the deployed position. For example, the crane base may be capable of moving in a first, vertical movement direction and in a second, horizontal movement direction relative to the longitudinal axis of the service unit. In one embodiment, these movements may be performed simultaneously. By way of further example, the crane base may be movable in an upward or downward direction relative to the service unit in the first, vertical movement direction. Additionally, or alternatively, the crane base may be moveable laterally in a frontward or backward direction and/or in a side-to-side direction in the second, horizontal movement direction relative to the service unit.

In one embodiment, the crane base may be operatively attached to a base wall of the service unit with a plurality of lift assemblies configured to move the crane base in the first, vertical movement direction. In another embodiment, the plurality of lift assemblies each include a roller assembly configured to facilitate movement of the crane base in the second, horizontal movement direction. In a further embodiment, the crane base may be supported on a rail system of the service unit configured to move the crane base in the second, horizontal movement direction. In one embodiment, hydraulic units may be used to provide the movement in the first, vertical movement direction and/or the second, horizontal movement direction. In another embodiment, a pulley system, including one or more pulleys and cables connected between attachment points on the crane base and one or more attachment points on the service unit or the main unit of the wind turbine nacelle, may be used for moving the crane base in the second, horizontal movement direction.

In one embodiment, the mounting interface may be supported from the crane base by a support arm that defines a longitudinal axis of the crane base. The longitudinal axis of the crane base may be generally parallel with the longitudinal axis of the service unit when in the stored position. Moreover, the longitudinal axis of the crane base may be generally perpendicular to the longitudinal axis of the service unit when in the deployed position. In another embodiment, the crane includes a yaw system configured to rotate the crane base between the stored position and the deployed position.

In one embodiment, a top wall of the service unit may be removable during operation of the crane. For example, the top wall of the service unit may be foldable, retractable, slidable, etc. in order to provide an opening to allow the crane to access wind turbine components external to the service unit, such as in the main unit or on the ground. In one embodiment, the crane base may be located adjacent one of either the first end or the second end of the frame of the service unit. Preferably, the crane base is located adjacent the end of the service unit that is most adjacent the base frame in the main unit of the nacelle.

In a second aspect of the invention, a wind turbine maintenance assembly is disclosed. The wind turbine maintenance assembly includes a main unit of a nacelle having a main housing outer wall and a base frame having a mounting pad, the base frame configured to be attached to a tower of a wind turbine. The wind turbine maintenance assembly further includes the service unit according to the first aspect described above secured to the main unit so as to be located alongside the main housing outer wall. The mounting interface of the crane in the service unit is connected to the mounting pad of the base frame in the main unit. In this way, the crane and loads associated therewith are directly supported by the primary load-bearing part of the nacelle.

In a third aspect of the invention, a wind turbine includes a tower and the wind turbine maintenance assembly according to the second aspect described above coupled to the tower.

In yet another aspect of the invention, a method of erecting or servicing a wind turbine is disclosed. The method includes providing a wind turbine nacelle that supports a rotor assembly defining a rotation axis of the wind turbine, the wind turbine nacelle including a main unit having a main housing outer wall and a base frame with a mounting pad, the base frame configured to be attached to a tower of the wind turbine; providing a service unit having a crane located within the service unit, the crane including a crane base having a mounting interface, the crane base being rotatably movable between a stored position, wherein the mounting interface is positioned within an interior of the service unit, and a deployed position; attaching the service unit to the main unit of the nacelle such that the service unit is located alongside the main housing outer wall; moving the crane base from the stored position to the deployed position, wherein this step includes rotating the crane base to position the mounting interface within the main unit of the nacelle; and coupling the mounting interface of the crane base to the mounting pad of the base frame.

In one embodiment, moving the crane base from the stored position to the deployed position may further include moving the crane base in an upward or downward direction in a first, vertical movement direction relative to the rotation axis of the wind turbine nacelle. Additionally, or alternatively, moving the crane base may include moving the crane base laterally in a frontward or backward direction and/or in a side-to-side direction in a second, horizontal movement direction relative to the rotation axis of the wind turbine nacelle. In one embodiment, the crane includes a yaw system and moving the crane base includes operating the yaw system to rotate the crane base between the stored position and the deployed position. These movement may be performed to align the mounting interface of the crane base with the mounting pad of the base frame.

In one embodiment, moving the crane base may include moving the crane base in the first, vertical movement direction and in the second, horizontal movement direction relative to the rotation axis of the wind turbine nacelle. These may be performed simultaneously.

In one embodiment, the method may further include hoisting the main unit of the wind turbine nacelle to a top of the wind turbine tower and hoisting the service unit to the main unit of the nacelle with the crane base in the stored position. In another embodiment, the method may further include attaching the service unit to the main unit of the nacelle such that the service unit is located alongside the main housing outer wall, and hoisting the main unit of the nacelle having the service unit attached thereto to a top of the wind turbine tower.

### BRIEF DESCRIPTION OF THE DRAWINGS

The accompanying drawings, which are incorporated in and constitute a part of this specification, illustrate embodiments of the invention and, together with a general description of the invention given above, and the detailed description given below, serve to explain the invention.

FIG. 1 is a perspective view of a wind turbine having a nacelle, illustrating a service unit attached to the side of a main nacelle unit of the a nacelle;

FIG. 2 is a perspective view of the wind turbine of FIG. 1, with the blades removed for clarity, illustrating the service unit being hoisted to the main nacelle unit.

FIG. 3 is a close-up, perspective view of the nacelle of the wind turbine in FIG. 1, with the blades removed for clarity;

FIG. 4 is a view similar to FIG. 3, illustrating the crane in an expanded configuration with a boom of the crane extending through a removable top wall of the service unit;

FIG. 5 is a partial, cross-sectional view of the main nacelle unit and the service unit in FIGS. 1, 3 and 4, illustrating the service unit crane in a collapsed configuration with a base of the crane in a stored position;

FIG. 6 is a perspective view of a mounting pad of a base frame in the main nacelle unit according to one embodiment of the invention;

FIGS. 7A-7D are partial, cross-sectional plan views of the service unit and the main nacelle unit of FIG. 1, illustrating movement of a base of the crane from a stored position to a deployed position;

FIGS. 8A-8C are side, partial cross-sectional views of the main nacelle unit and the service unit in FIG. 1, further illustrating movement of the base of the crane from the stored position to the deployed position; and

FIG. 9 is a partial, cross-sectional plan view of the service unit and the main nacelle unit, illustrating a base of the crane in accordance with another embodiment of the invention.

### DETAILED DESCRIPTION

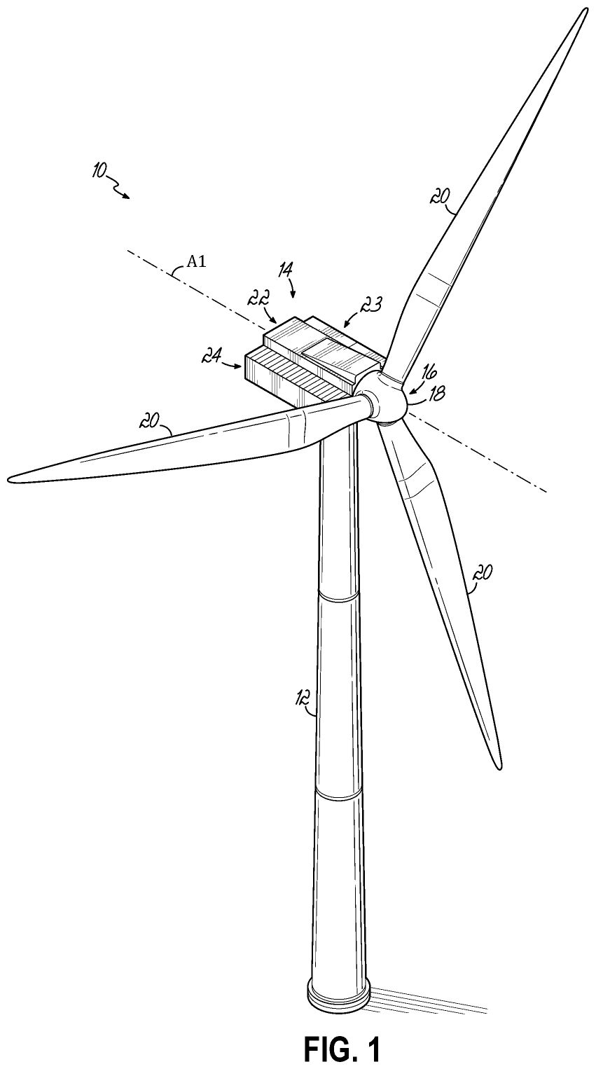

Referring to FIG. 1, a wind turbine 10 includes a tower 12, a nacelle 14 disposed at the apex of the tower 12, and a rotor 16 operatively coupled to a generator (not shown) housed inside the nacelle 14, and a gearbox (not shown) also housed inside the nacelle 14. In addition to the generator and gearbox, the nacelle 14 may house various components needed to convert wind energy into electrical energy and to operate and optimize the performance of the wind turbine 10. The tower 12 supports the load presented by the nacelle 14, rotor 16, and other wind turbine components housed inside the nacelle 14, or external to the nacelle, and operates to elevate the nacelle 14 and the rotor 16 to a height above ground level or sea level, as may be the case, at which air currents having lower turbulence and higher velocity are typically found. The nacelle 14, and more particularly the rotor 16 defines a rotation axis A1 of the wind turbine 10 that is generally aligned with the direction of the oncoming wind during the operation of the wind turbine 10.

The rotor 16 may include a central hub 18 and a plurality of blades 20 attached to the central hub 18 at locations distributed about the circumference of the central hub 18. In the representative embodiment, the rotor 16 includes three blades 20, however the number may vary. The blades 20, which project radially outward from the central hub 18, are configured to interact with passing air currents to produce rotational forces that cause the central hub 18 to spin about its longitudinal axis which is coaxial with the rotation axis A1. The design, construction, and operation of the blades 20 are familiar to a person having ordinary skill in the art of wind turbine design and may include additional functional aspects to optimize performance. For example, pitch angle control of the blades 20 may be implemented by a pitch control mechanism (not shown) responsive to wind velocity to optimize power production in low wind conditions, and to feather the blades 20 if wind velocity exceeds design limitations.

The rotor 16 may be coupled to the gearbox directly or indirectly by a drive shaft (not shown) to form a rotor assembly. Either way, the gearbox transfers the rotation of the rotor 16 through a coupling (not shown) to the generator. Wind exceeding a minimum speed may activate the rotor 16, causing the rotor 16 to rotate in a direction substantially perpendicular to the wind, applying torque to the input shaft of the generator. The electrical power produced by the generator may be supplied to a power grid (not shown) or an energy storage system (not shown) for later release to the grid as understood by a person having ordinary skill in the art. In this way, the kinetic energy of the wind may be harnessed by the wind turbine 10 for power generation.

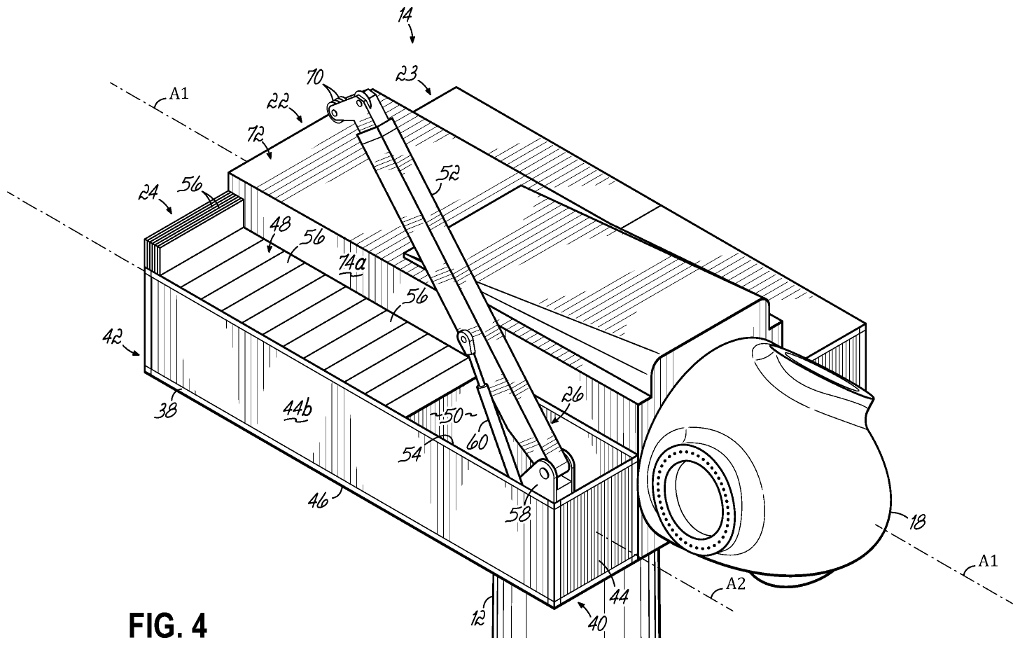

With continued reference to FIG. 1, the nacelle 14 is formed from a main nacelle unit 22 and one or more auxiliary nacelle units 23 removably affixed to a side of the main nacelle unit 22. The one or more auxiliary nacelle units 23 may contain one or more wind turbine components such as a transformer and converter, for example. The wind turbine 10 further includes a service unit 24 removably affixed to the other side of the main nacelle unit 22. The service unit 24 includes a crane 26 (FIG. 4) as well as equipment and components needed to perform installation (e.g., initial installation of the wind turbine 10) and/or maintenance activities on the wind turbine 10. The service unit 24 may only be temporarily installed to the main nacelle unit 22, such as for the duration of installation and/or maintenance activities on the wind turbine 10. The temporary installation of the service unit 24 to the main nacelle unit 22 forms a wind turbine maintenance assembly, which includes the main nacelle unit 22 and the temporary service unit 24. To this end, the service unit 24 does not typically form a permanent part of the nacelle 14. The service unit 24 may be formed with a size and/or the outer shape comparable to the size and shape of a shipping freight container. To this end, a shipping freight container, also referred to as an intermodal container (ISO), a standard freight container, or a box container, refers to a general container used to store and move materials and products in the global containerized intermodal freight transport system for intercontinental shipping and may adhere to the dimensional and structural specifications in the ISO standard for series 1 freight containers.

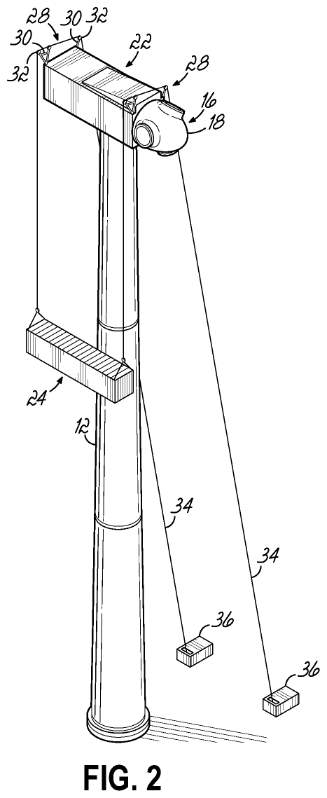

Referring to FIG. 2, in one embodiment, the main nacelle unit 22 includes one or more external crane assemblies 28 for raising the service unit 24 to the main nacelle unit 22 and for lowering the service unit 24 from the main nacelle unit 22 once the service unit 24 is no longer needed, for example, after the completion of installation and maintenance activities on the wind turbine 10. As shown, each crane assembly 28 includes one or more frame members 30, pulleys 32, and one or more cables 34 routed through the crane assemblies 28 and between a winch 36 and the service unit 24 for raising/lowering the service unit 24. In this regard, the service unit 24 is transported to the wind turbine site and hoisted up to the main nacelle unit 22 using the crane assemblies 28 and releasably attached to the main nacelle unit 22, as described in further detail below. It should be noted that other types of cranes may be used to hoist the service unit 24 to the top of the tower 12. It should be further noted that the plurality of blades 20 have been omitted in this figure to better illustrate details of the external crane assemblies 28.

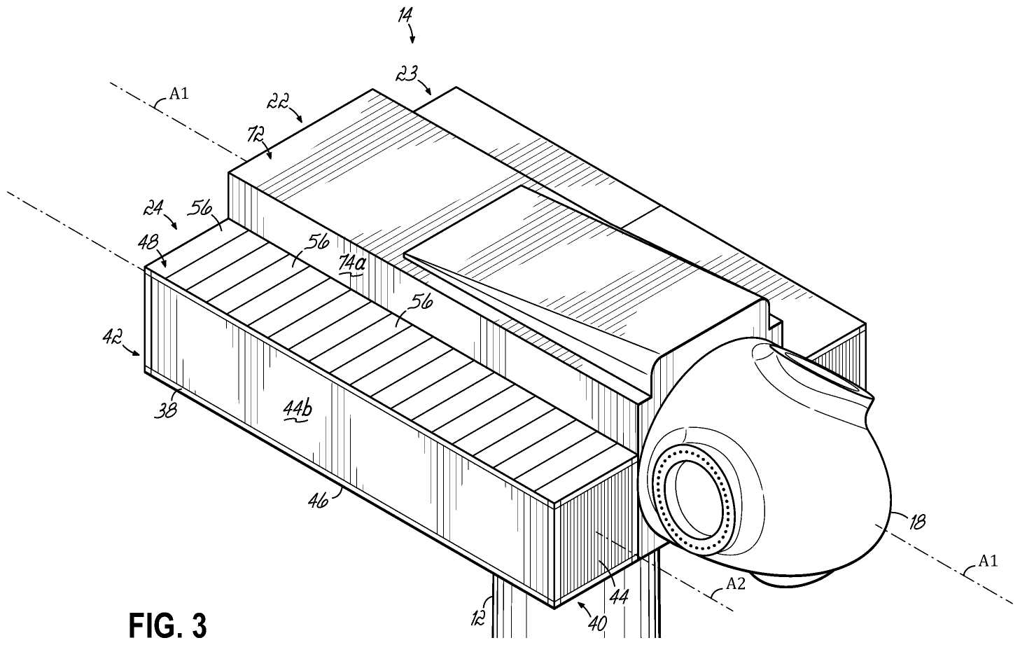

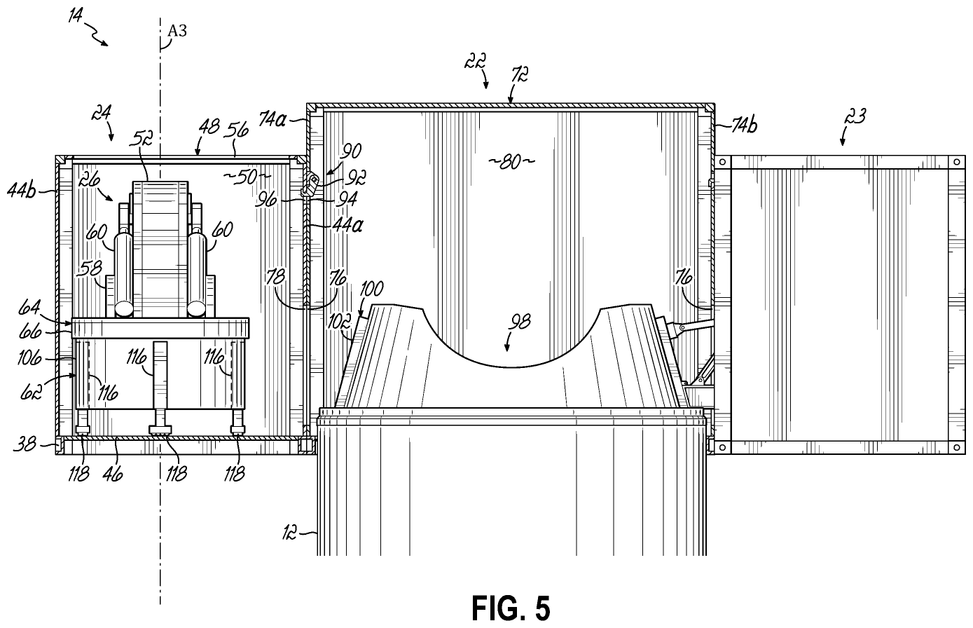

Referring to FIGS. 3 and 4, the service unit 24 includes a frame 38 that extends between a first end 40 and an opposite second end 42 to define a longitudinal axis A2 of the service unit 24. When the service unit 24 is attached to the main nacelle unit 22, as shown, the longitudinal axis A2 of the service unit 24 may be generally parallel with the rotation axis A1 of the wind turbine 10. The service unit 24 includes a plurality of sidewalls 44, 44a, 44b, a base wall 46, and a top wall 48 which together define an interior 50 of the service unit 24. The crane 26 is located within the interior 50 of the service unit 24 and is movable between a collapsed configuration in which the crane 26 is completely enclosed within the interior 50 of the service unit 24, as shown in FIGS. 3 and 5, and an expanded configuration in which at least a telescoping boom 52 of the crane 26 extends through an opening 54 formed in the top wall 48 of the service unit 24, as shown in FIG. 4. As will be described in further detail below, the crane 26 is configured to be attached directly to the main nacelle unit 22 to form a load path through the main nacelle unit 22 such that the crane 26 remains with and operates from the service unit 24.

With continued reference to FIG. 4, the top wall 48 of the service unit 24 may be removable, or partially removable, so that the crane 26, and more particularly the boom 52 of the crane 26, may extend through the opening 54 in the top wall 48 of the service unit 24 to perform installation and maintenance activities on the wind turbine 10. In this regard, the top wall 48 of the service unit 24 may comprise a plurality of interconnected panels 56 configured to fold or slide relative to one another at one end 40, 42 of the service unit 24 to incrementally retract the top wall 48 to form the opening 54 through which the crane boom 52 may extend during operation, as shown. To this end, a size of the opening 54 may be adjusted as desired. Furthermore, the service unit 24 may comprise accommodation facilities for personnel performing installation and maintenance activities. Such facilities may include, for example, a workshop, a spare part storage, a toilet, a kitchen, or a bathroom, etc. To this end, the top wall 48 of the service unit 24 may be partially removed to form the opening 54 for the crane 26, yet still cover a portion of the service unit 24 having facilities for personnel performing installation and maintenance activities.

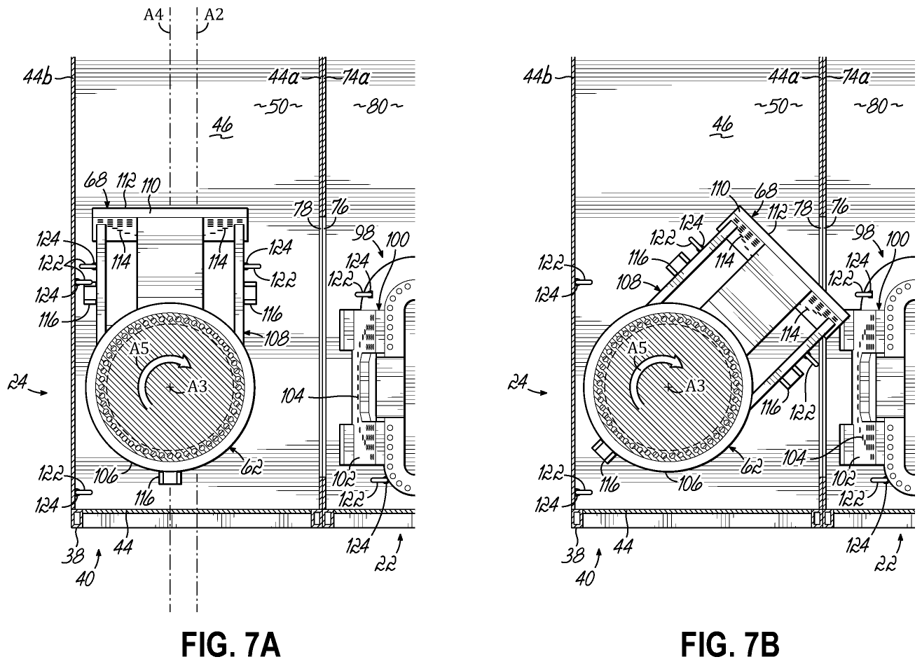

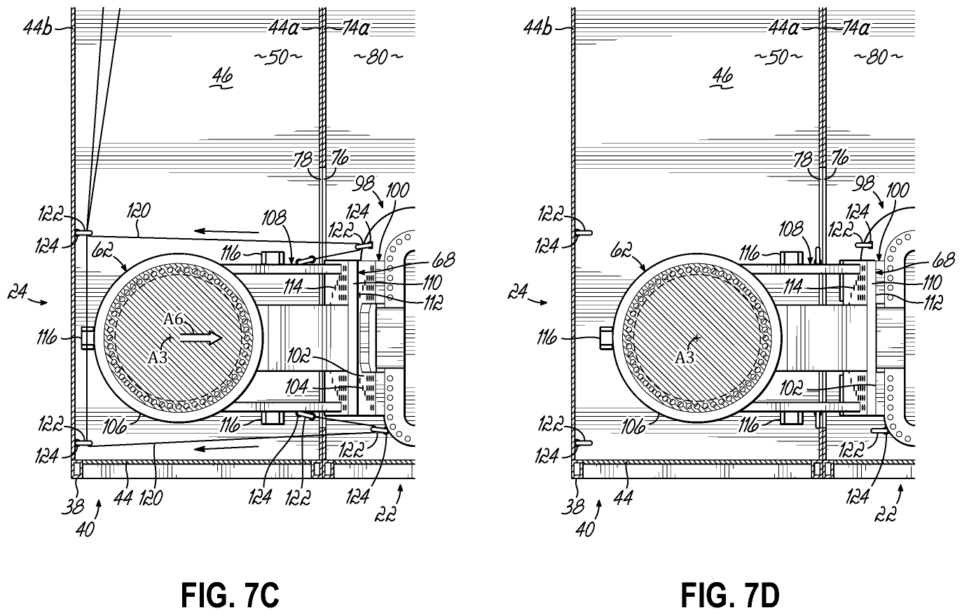

With reference to FIGS. 4 and 5, the crane 26 includes the boom 52 pivotally connected to a pedestal 58 with pivotal movement of the boom 52 driven by a pair of main hydraulic cylinders 60. The crane pedestal 58 is operatively coupled to a crane base 62 via a yaw system 64 that includes a yaw bearing 66 driven by a yaw motor (not shown) for rotating the crane pedestal 58 and the crane base 62 relative to one another. As will be described in further detail below, the crane base 62 is movable relative to the service unit 24 and the crane pedestal 58 to locate a mounting interface 68 of the crane base 62 (e.g., FIGS. 7A-7D) within the main nacelle unit 22 for attachment thereto. The crane 26 may also include one or more pulleys 70 configured to receive a crane cable (not shown) having a load block for lifting wind turbine components. To this end, the crane cable may be reeled by a power-driven winch (not shown), as should be understood by a person of ordinary skill in the art. The crane 26 may comprise a power interface configured to releasably connect to a power supply in the main unit 22, such as an electric or hydraulic power supply, for example.

Referring now to FIG. 5, the main nacelle unit 22 includes a main housing 72 with opposing main housing outer walls 74a, 74b. In that regard, the service unit 24 is configured to be releasably attached to a main housing outer wall 74a, 74b of the main nacelle unit 22 to form a planar interface therebetween. In particular, the planar interface may be defined by engagement between an elongate sidewall 44a, 44b of the service unit 24 and the corresponding outer wall 74a, 74b of the main nacelle unit 22. As shown, each of the main housing outer walls 74a, 74b has an opening 76 and a corresponding one of the elongate sidewalls 44a, 44b of the service unit 24 includes a corresponding opening 78 configured to align with the opening 76 when the service unit 24 is connected to the main nacelle unit 22, as shown. The aligned openings 76, 78 place the interior 50 of the service unit 24 in communication with an interior 80 of the main nacelle unit 22.

With continued reference to FIG. 5, one or more attachment mechanism 90 are used to releasably attach the service unit 24 to the main nacelle unit 22. As shown, each attachment mechanism 90 includes a latch 92 pivotally connected to the main housing outer wall 74a. The main housing outer wall 74a includes an opening 94 which is configured to allow the latch 92 to pass a least partially therethrough as depicted in FIG. 5, for example. In that regard, during installation of the service unit 24 to the main nacelle unit 22, the service unit 24 may be lowered down until the latch 92 is captured in an opening 96 formed in the elongate sidewall 44a of the service unit 24. The engagement between the latch 92 of each attachment mechanism 90 and the service unit 24 supports the service unit 24 from the main nacelle unit 22. To this end, a plurality of attachment mechanisms 90 may be arranged along each of the main housing outer walls 74a, 74b of the main nacelle unit 22 to support the service unit 24 on either side of the main nacelle unit 22, for example.

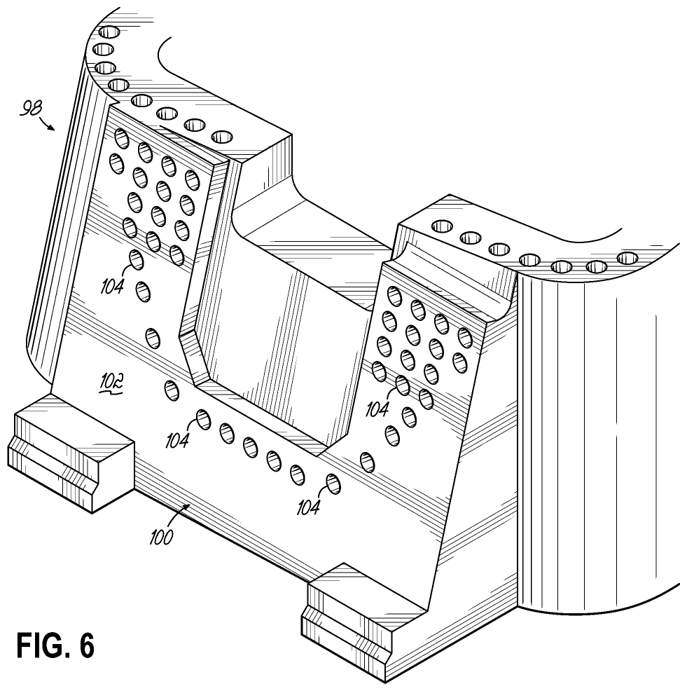

With reference to FIGS. 5 and 6, the main nacelle unit 22 includes a base frame 98 disposed within the interior 80 of the main nacelle unit 22. The base frame 98 is configured to be attached to the tower 12 of the wind turbine 10 to thereby couple the main nacelle unit 22 to the tower 12. As shown, the base frame 98 includes a mounting pad 100 configured to receive the mounting interface 68 of the crane base 62 (e.g., FIGS. 7A-7D) to couple the crane 26 to the base frame 98 and the main nacelle unit 22, as described in further detail below. As shown in FIG. 6, the mounting pad 100 defines a raised, plate-like engagement surface 102 configured to mate with the mounting interface 68 of the crane base 62. The engagement surface 102 is generally U-shaped, however, other configurations are possible, such as a square or rectangular shape, for example. The engagement surface 102 includes a plurality of bores 104 formed therein for receiving mounting hardware, such as bolts or other suitable fasteners, for attaching the crane base 62 to the base frame 98. To this end, because the crane 26 is configured to be supported by the base frame 98 in the main nacelle unit 22, the load path for the crane 26 and its associated loads is not directed through the sidewalls 44a, 44b of the service unit 24 and the main housing outer walls 74a, 74b of the main nacelle unit 22. Thus, the sidewalls 44a, 44b, 74a, 74b and the attachment mechanisms 90 may be designed to accommodate smaller loads.

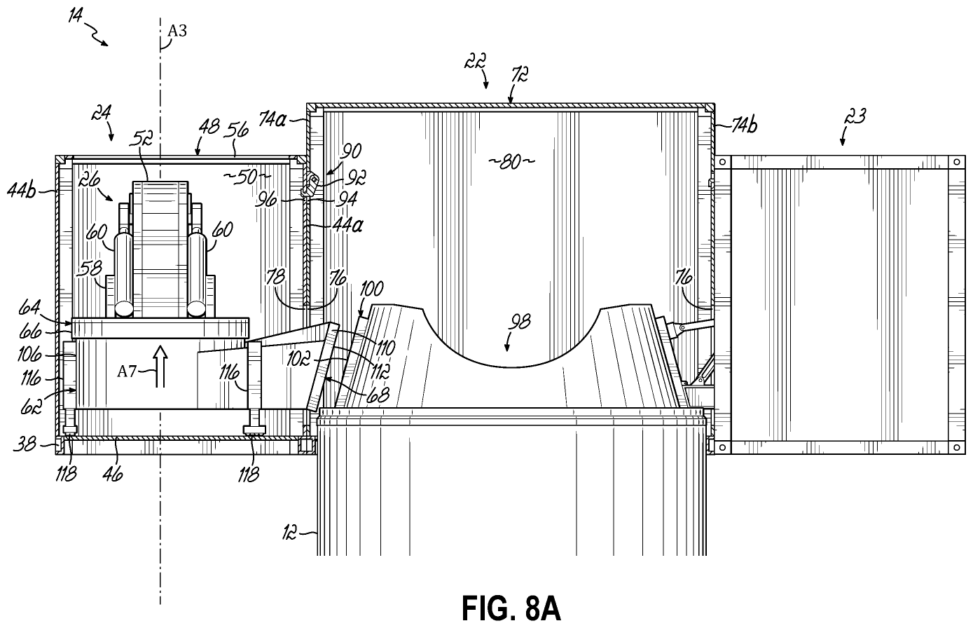

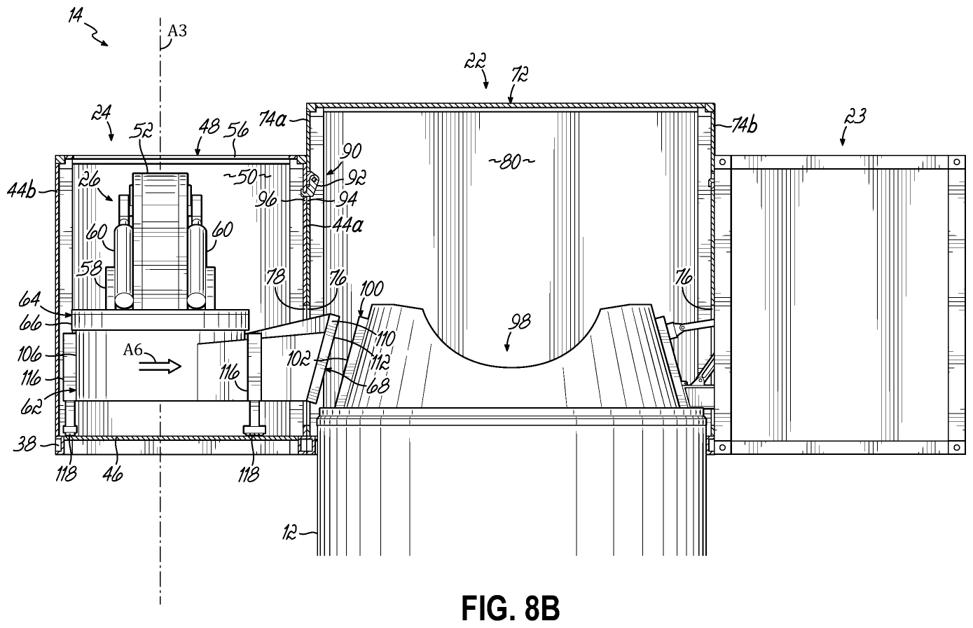

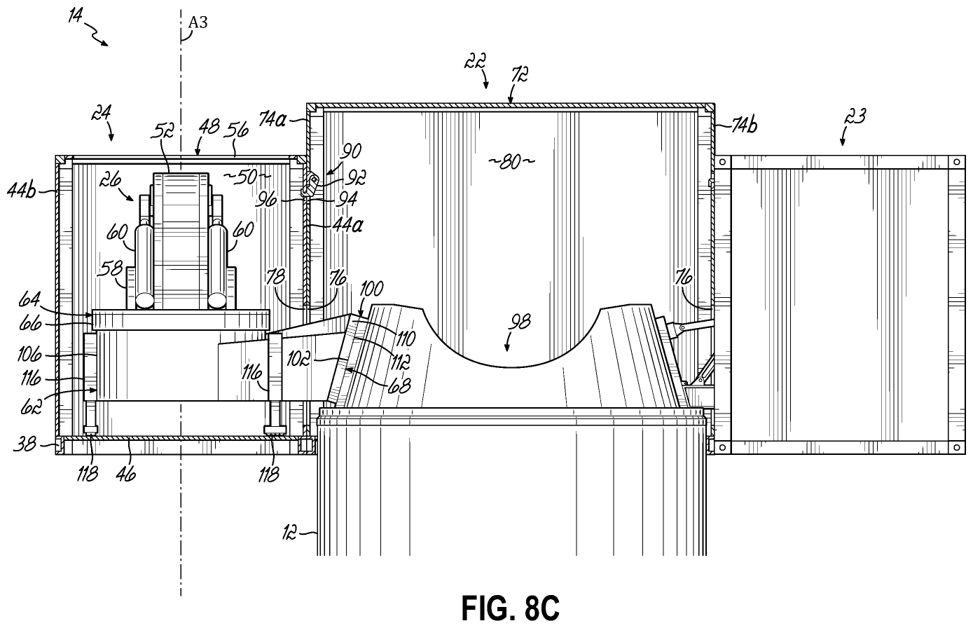

As briefly described above, the crane base 62 is movable relative to the service unit 24 to move the mounting interface 68 of the crane base 62 into the main nacelle unit 22 for attachment to the base frame 98. In that regard, the crane base 62 is movable between at least a stored position where the mounting interface is positioned within the interior 50 of the service unit 24, as shown in FIG. 5, and a deployed position where the crane base 62 is rotated to locate the mounting interface 68 within the main nacelle unit 22, as shown in FIGS. 7D and 8C, for example. In that regard, the crane base 62 is in the stored position while the service unit 24 is being transported and during hoisting operations of the service unit 24 to/from the main nacelle unit 22, for example. To this end, the crane 26 is also in the collapsed position when the crane base 62 is in the stored position during transportation of the service unit 24.

With continued reference to FIGS. 5 and 7A-7D, the crane base 62 includes a generally cylindrical body 106 and a support arm 108 that extends from the body 106 of the crane base 62 to the mounting interface 68. In particular, the support arm 108 is arranged generally perpendicular to a rotation axis A3 of the body 106 of the crane base 62 to space the mounting interface 68 a distance away from the body 106 of the mounting base 62. In that regard, the support arm 108 of the crane base 62 defines a longitudinal axis A4 of the crane base 62 that is perpendicular to the rotation axis A3 of the crane base 62. The support arm 108 has a fixed length configured to extend between the service unit 24 and the main nacelle unit 22 to place the mounting interface 68 in engagement with the mounting pad 100 of the base frame 98. In that regard, the mounting interface 68 includes a generally plate-like bracket 110 that defines an engagement surface 112 configured to mate with the engagement surface 102 of the mounting pad 100. As shown, a profile of the bracket 110 generally corresponds to a profile of the mounting pad 100. In particular, a profile of the engagement surface 112 of the bracket 110 generally corresponds to a profile of the engagement surface 102 of the mounting pad 100. To this end, the bracket 110 includes a plurality of bores 114 formed therein in a pattern that corresponds to the bores 104 formed in the mounting pad 100 so that fasteners may be received through aligned bores 114, 104 to attach the crane base 62 to the base frame 98.

Due to the large size of the crane base 62 and yaw system 64, as can be seen in FIGS. 7A-7D, a longitudinal length of the crane base 62 (i.e., a length of the crane base 62 measured along the longitudinal axis A4) is greater than a width of the service unit 24 (i.e., a distance measured between elongate sidewalls 44a, 44b of the service unit 24). The large size of the crane base 62 is to accommodate the increased size of wind turbine components, for example. In any event, to accommodate for large size of the crane base 62, the crane base 62 is movable, and in particular rotatably movable, to move the mounting interface 68 through the aligned openings 76, 78 in the sidewalls 44a, 74b and into the main nacelle unit 22, as described in further detail below.

With reference to FIG. 5, the body 106 of the crane base 62 is operatively supported above the base wall 46 of the service unit 24 with a plurality of lift assemblies 116 configured to move the crane base 62 and the crane 26 in a first, vertical movement direction. To support the weight of the crane base 62, the base wall 46 of the service unit 24 may include a reinforcing base plate. In any event, the plurality of lift assemblies 116 engage the base wall 46 of the service unit 24 and may operate as support legs for the crane base 62, for example. The crane base 62 may include three lift assemblies 116, with one lift being attached to the body 106 of the crane base 62 and two lift assemblies 116 being attached to the support arm 108 of the crane base 62. However, the crane base 62 may include fewer or more lift assemblies 116 attached to different locations on the crane base 62. The lift assemblies 116 comprise hydraulic or pneumatic cylinders configured to adjust a height of the crane base 62 relative to the base wall 46 of the service unit 24 and the base frame 98 of the main nacelle unit 22, for example.

With continued reference to FIG. 5, each of the plurality of lift assemblies 116 includes a roller assembly 118 configured to operatively engage the base wall 46 of the service unit 24. In this regard, the roller assemblies 118 may form the only points of engagement between the crane base 62 and the base wall 46 of the service unit 24. The roller assemblies 118 permit movement of the crane base 62 in a second, horizontal movement direction. The roller assemblies 118 also permit for rotational movement of the crane base 62 about the rotation axis A3. To this end, the lift assemblies 116 provide for rotational movement of the crane base 62 about the rotation axis A3, and further provide for movement of the crane base 62 in two directions of motion (i.e., a horizontal movement direction and a vertical movement direction) relative to the service unit 24 to move the crane base 62 between the stored position (e.g., FIG. 5) and the deployed position (e.g., FIGS. 7D and 8C).

To prevent unwanted movement of the crane 26 during transport of the service unit 24 to the wind turbine site, as well as during hoisting of the service unit 24 to/from the main nacelle unit 22, the lift assemblies 116 are lowered to lower the crane base 62 to the base wall 46 of the service unit 24 and the crane base 62 fixed with chains or cable to the service unit 24. The boom 52 of the crane 26 may also be secured to the service unit 24 to prevent unwanted movement of the boom 52 during transport of the service unit 24 as well. In particular, a boom support stand (not shown) may be used to operatively support the boom 52 when in the collapsed position. The boom support stand may include one or more lift assemblies 116 configured to accommodate for movement of the crane 26 and the crane base 62 as it is moved from the stored position to the deployed position, as described in further detail below.

Having now described certain details of the service unit 24 and the main nacelle unit 22, an exemplary sequence whereby the crane base 62 is moved from the stored position to the deployed position after the service unit 24 is attached to the main nacelle unit 22 will now be described in connection with FIGS. 7A-8C. FIG. 7A depicts the service unit 24 adjacent to the main nacelle unit 22 after having just been hoisted to the main nacelle unit 22 and attached to the main nacelle unit 22 with the attachment mechanisms 90, as described above. In that regard, the crane 26 is still in the collapsed configuration and the crane base 62 is in the stored position. When in the stored position, the mounting interface 68 of the crane base 62 is positioned within the interior 50 of the service unit 24. In particular, the crane base 62 is oriented such that the longitudinal axis A4 of the crane base 62 is generally parallel with the longitudinal axis A2 of the service unit 24. As shown, the crane base 62 is located adjacent to the end 40 of the service unit 24 having the opening 78 formed therein. Notably, the crane base 62 is slightly offset toward the sidewall 44b of the service unit 24 opposite the sidewall 44a having the opening 78 formed therein so as to be positioned away from the main nacelle unit 22. Locating the crane base 62 closer to the outermost sidewall 44b of the service unit 24 from the main nacelle unit 22, as shown, ensures adequate clearance is available to rotate the crane base 62 through the aligned openings 76, 78 in the sidewalls 44a, 74b, as described in further detail below.

FIG. 7B depicts the crane base 62 being moved from the stored position. In particular, the crane base 62 is rotated about the rotation axis A3 to move the mounting interface 68 through the aligned openings 76, 78 in the sidewalls 44a, 74b and into the interior 80 of the main nacelle unit 22, as indicated by directional arrow A5. During rotation of the crane base 62, the yaw system 64 of the crane 26 may be disengaged such that the crane base 62 may be rotated without a corresponding rotation of the boom 52 of the crane 26 (i.e., the boom 52 remains in a fixed position). Rotation of the crane base 62 about the rotation axis A3 may be performed using a system of cables 120 and pulleys 122 (e.g., FIG. 7C) to maneuver the crane base 62 about the service unit 24. Some of the pulleys 122 may be in the form of a hoist ring or shackle, for example. In that regard, the pulleys 122 form attachment points 124 on the service unit 24, crane base 62, and main nacelle unit 22 that can be used to rotate the crane base 62 and move the crane base 62 in the second, horizontal movement direction, as described in further detail below. The cables 120 may be attached to a winch or pulled by hand. In another embodiment, rotation of the crane base 62 may be done automatically using the yaw system 64 of the crane 26, for example.

FIG. 7C depicts the crane base 62 rotated approximately 90° from its initial, stored position, to locate the mounting interface 68 within the interior 80 of the main nacelle unit 22. In this regard, the longitudinal axis A4 of the crane base 62 is generally perpendicular to the longitudinal axis A2 of the service unit 24. When so positioned, the crane base 62 remains in the service unit 24 with the support arm 108 extending through the aligned openings 76, 78 in the sidewalls 44a, 74b. However, after rotating the crane base 62, the mounting interface 68 may still be spaced a distance away from the mounting pad 100. As such, cables 120 are routed through desired pulleys 122 (or attachment points) and used to move the crane base 62 in the second, horizontal movement direction toward the mounting pad 100, as indicated by directional arrow A6. In particular, the crane base 62 is moved in the horizontal movement direction away from the sidewall 44b and toward the main nacelle unit 22 and a center of the service unit 24 (i.e., a midpoint between the elongate sidewalls 44a, 44b of the service unit 24). To this end, the crane base 62 may be moved in any lateral movement direction relative to the service unit 24 to align the mounting interface 68 with the mounting pad 100 of the base frame 98. As such, movement in the horizontal movement direction includes lateral movement in a frontward or backward direction (i.e., toward or away from sidewalls 44a, 44b) and in a side-to-side direction (i.e., toward or away from sidewalls 44), or any combination of lateral movement in the horizontal movement direction relative to the service unit 24.

The crane base 62 is moved in the horizontal movement direction until the mounting interface 68 abuts the mounting pad 100, as shown in FIG. 7D. When so positioned, fasteners may be received through aligned bores 114, 104 to attach the crane base 62 to the base frame 98. In that regard, the crane base 62 is considered to be in its deployed positioned. To this end, attachment of the crane base 62 to the base frame 98 forms a load path of the crane 26 through the base frame 98 of the main nacelle unit 22, as described above.

Referring now to FIGS. 8A-8C, at any point before or during either the rotational movement of the crane base 62, or movement of the crane base 62 in the horizontal movement direction, a height of the crane base 62 may be adjusted using the plurality of lift assemblies 116. In that regard, FIG. 8A depicts the crane base 62 after it has been rotated 90° from its initial, stored position. To align the mounting interface 68 with the mounting pad 100, the crane base 62 is raised in a vertical movement direction using the lifting assemblies 116, as indicated by directional arrow A7. However, it is possible that the crane base 62 may need to be lowered in the vertical movement direction to align the mounting interface 68 with the mounting pad 100. As such, movement in the vertical movement direction includes upward or downward movement of the crane base 62 along the rotation axis A3 relative to the service unit 24 and main nacelle unit 22. In any event, once the mounting interface 68 is aligned in the vertical movement direction with the mounting pad 100, the crane base 62 may be moved in the horizontal movement direction toward the mounting pad 100, as indicated by directional arrow A6 in FIG. 8B. The crane base 62 is moved in the horizontal movement direction until the mounting interface 68 abuts the mounting pad 100, as shown in FIG. 8C. To this end, FIG. 8B is a side view of the crane base 62 illustrated in FIG. 7C, and FIG. 8C is a side view of the crane base 62 illustrated in FIG. 7D.

As illustrated in FIGS. 7D and 8C, the crane base 62 is in the deployed position, attached to the base frame 98 of the main nacelle unit 22 such that the crane 26 remains external to the main housing 72 of the main nacelle unit 22. The crane base 62 is positioned above the base wall 46 of the service unit 24 such that substantially all of the weight of the crane 26, including any loads being lifted by the crane 26, is transmitted to the base frame 98. In this way, the weight of the crane 26 and its payload are not borne by the sidewalls 44a, 74a of the service unit 24 and the main nacelle unit 22, respectively, but instead the crane 26 has a direct load path to the base frame 98 in the main nacelle unit 22.

To uninstall the crane 26 from the main nacelle unit 22, the mounting interface 68 is uncoupled from the mounting pad 100 and the crane base 62 moved in the horizontal movement direction away from the base frame 98 and in a direction toward the sidewall 44b of the service unit 24. The crane base 62 may then be rotated back to the stored position, as shown in FIG. 7A, for example. At any point, the crane base 62 may be lowered or raised in the vertical movement direction to a desired height for storage. Once the crane base 62 is in the stored position, and the crane boom 52 in the collapsed position, the service unit 24 may be disengaged from the respective main housing outer wall 74a, 74b and lowered from the main nacelle unit 22.

The lift assemblies 116 in combination with the system of cables 120 and pulleys 122 and/or attachment points, provides for rotational movement of the crane base 62, and in particular the mounting interface 68, and both movement of the crane base 62 in a vertical movement direction and a horizontal movement direction. Movement of the crane base 62 in the vertical movement direction and the horizontal movement direction may be simultaneous, for example, and movement in either the vertical or horizontal movement direction does not necessarily need to occur in any specific order.

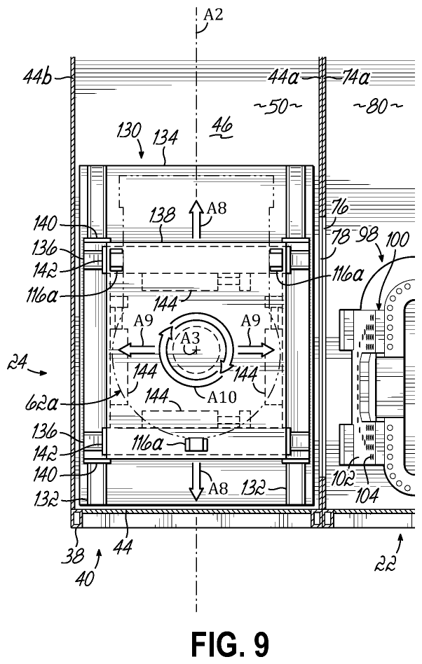

Referring now to FIG. 9, wherein like numerals represent like features compared to the embodiment described above with respect to FIGS. 1-8C, a crane base 62a is shown in accordance with another embodiment of the present invention. The primary differences between the crane base 62a of this embodiment and the crane base 62 of the previously described embodiment is that the crane base 62a is supported on a rail system 130 configured to move the crane base 62a in the horizontal movement direction. The rail system 130 is attached to the base wall 46 of the service unit 24 and includes a first pair of rails 132 arranged on a first base plate 134 and a second pair of rails 136 arranged on a second base plate 138. The first pair of rails 132 may extend in a lengthwise direction of the service unit 24 (i.e., in parallel with the longitudinal axis A2 of the service unit 24) and the second pair of rails 136 may extend in a widthwise direction of the service unit 24 (i.e., perpendicular to the longitudinal axis A2 of the service unit 24). As shown, the second base plate 138 and pair of rails 136 are stacked on top of the first base plate 134 and pair of rails 132. In particular, the second pair of rails 136 extend between a pair of slides 140 that are slideable along the first pair of rails 132. The second base plate 138 includes a pair of slides 142 that are slideable along the second pair of rails 136. To this end, the first pair of rails 132 provides for horizontal or lateral movement of the crane base 62a in a side-to-side direction (i.e., toward or away from sidewalls 44), as indicated by directional arrows A8, and the second pair of rails 136 provides for horizontal movement of the crane base 62a in a forward or backward direction (i.e., toward or away from sidewalls 44a, 44b), as indicated by directional arrows A9, relative to the service unit 24.

The lift assemblies 116a are attached directly to the second base plate 138 of the rail system 130, which may include a yaw system, such as a sliding bearing, slewing bearing, or other suitable structure configured to permit rotational movement of the crane base 62a relative to the rail system 130, as indicated by directional arrows A10. To this end, rotation of the crane base 62a about the rotation axis A3 may be performed using a system of cables and pulleys, as described above, or the yaw system 64 of the crane 26a, for example. The rail system 130 includes one or more hydraulic or pneumatic cylinders 144 configured to effectuate movement of the crane base 62a in the horizontal movement directions, A8, A9. In another embodiment, a system of cables and pulleys may be used to effectuate movement of the crane base 62a in the horizontal movement directions, A8, A9.

The invention also contemplates a method of erecting the wind turbine 10. The method includes transporting a service unit 24 having a crane 26 located within the service unit 24 to a wind turbine site where a partially or fully assembled wind turbine 10 is located. The method includes lifting the service unit 24 to the main nacelle unit 22 and attaching the service unit 24 to the main nacelle unit 22 such that the service unit 24 is located alongside a main housing outer wall 74a, 74b, as described above. The method further includes moving the crane base 62 from the stored position to the deployed position, as described above with respect to FIGS. 7A-8C, and coupling the mounting interface 68 of the crane base 62 to the mounting pad 100 of the base frame 98. The method further includes uninstalling the crane base 62 from the base frame 98 of the main nacelle unit 22, moving the crane base 62 from the deployed position to the stored position and the boom 52 to the collapsed position, and releasing and lowering the service unit 24 from the main nacelle unit 22.

While the method above describes erecting the wind turbine 10 where the main nacelle unit 22 is already located at the apex of the tower 12, other methods are possible. For example, in an alternative embodiment, the service unit 24 may be attached to the main nacelle unit 22 before the main nacelle unit 22 is hoisted to the apex of the tower 12. The main nacelle unit 22 including the service unit 24 is then hoisted to the apex of the tower 12 for attachment thereto. The service unit 24 is then lowered from the main nacelle unit 22 once no longer needed.

While the present invention has been illustrated by a description of various preferred embodiments and while these embodiments have been described in some detail, it is not the intention of the Applicant to restrict or in any way limit the scope of the appended claims to such detail. Additional advantages and modifications will readily appear to those skilled in the art. Thus, the various features of the invention may be used alone or in any combination depending on the needs and preferences of the user.

1. A service unit for a wind turbine nacelle, the wind turbine nacelle including a main nacelle unit having a main housing outer wall and a base frame with a mounting pad, the base frame configured to be attached to a tower of the wind turbine, the service unit comprising:
a frame extending between a first end and an opposite second end to define a longitudinal axis (A2) of the service unit, and including sidewalls which define an interior of the service unit; and
a crane located within the interior of the service unit and including a crane base with a mounting interface configured to be connected to the mounting pad to couple the crane to the base frame of the main nacelle unit, wherein the crane base is rotatably movable between a stored position and a deployed position,
wherein in the stored position, the mounting interface is positioned within the interior of the service unit, and
wherein in the deployed position, the crane base extends through one of the sidewalls of the service unit for connection of the mounting interface to the mounting pad of the base frame in the main nacelle unit.

2. The service unit of claim 1, wherein the crane base is further movable in two directions of motion relative to the longitudinal axis (A2) of the service unit to move the crane base between the stored position and the deployed position.

3. The service unit of claim 2, wherein the crane base is capable of simultaneously moving in a first, vertical movement direction and in a second, horizontal movement direction relative to the longitudinal axis (A2) of the service unit.

4. The service unit of claim 3, wherein the crane base is movable in:
an upward or downward direction relative to the service unit in the first, vertical movement direction, and/or
laterally in a frontward or backward direction and/or in a side-to-side direction in the second, horizontal movement direction relative to the service unit.

5. The service unit of claim 2, wherein the crane base is operatively attached to a base wall of the service unit with a plurality of lift assemblies configured to move the crane base in the first, vertical movement direction.

6. The service unit of claim 2, wherein the plurality of lift assemblies each include a roller assembly configured to facilitate movement of the crane base in the second, horizontal movement direction.

7. The service unit of claim 2, wherein the crane base is supported on a rail system of the service unit configured to move the crane base in the second, horizontal movement direction.

8. The service unit of claim 2, further comprising a pulley system including one or more pulleys and cables connected between attachment points on the crane base and one or more attachment points on the service unit or the main nacelle unit of the wind turbine nacelle for moving the crane base in the second, horizontal movement direction.

9. The service unit of claim 1, wherein the mounting interface is supported from the crane base by a support arm that defines a longitudinal axis (A4) of the crane base, wherein the longitudinal axis (A4) of the crane base is generally in parallel with the longitudinal axis (A2) of the service unit when in the stored position.

10. The service unit of claim 1, wherein the longitudinal axis (A4) of the crane base is generally perpendicular to the longitudinal axis (A2) of the service unit when in the deployed position.

11. The service unit of claim 1, wherein a top wall of the service unit is removable.

12. The service unit of claim 1, wherein the engagement between the crane base and the base frame of the main nacelle unit is configured to form a load path of the crane through the base frame of the main nacelle unit.

13. The service unit of claim 1, wherein the crane base is located adjacent one of either the first end or the second end of the service unit.

14. The service unit of claim 1, wherein the crane includes a yaw system configured to rotate the crane base between the stored position and the deployed position.

15. A wind turbine maintenance assembly, comprising:
a main unit of a nacelle having a main housing outer wall and a base frame with a mounting pad, the base frame configured to be attached to a tower of a wind turbine; and
the service unit according to claim 1 releasably secured to the main unit so as to be located alongside the main housing outer wall,
wherein the mounting interface of the crane in the service unit is connected to the mounting pad of the base frame in the main unit.

16. A wind turbine, comprising:
a tower; and
the wind turbine maintenance assembly according to claim 15 connected to the tower.

17. A method of erecting or servicing a wind turbine, comprising:
providing a wind turbine nacelle that supports a rotor assembly defining a rotation axis (A1) of the wind turbine, the wind turbine nacelle including a main nacelle unit comprising a main housing outer wall and a base frame having a mounting pad, the base frame configured to be attached to a tower of the wind turbine;
providing a service unit having a crane located within the service unit, the crane comprising a crane base having a mounting interface, the crane base being rotatably movable between a stored position, wherein the mounting interface is positioned within an interior of the service unit, and a deployed position;
attaching the service unit to the main nacelle unit such that the service unit is located alongside the main housing outer wall;
moving the crane base from the stored position to the deployed position, including:
rotating the crane base to position the mounting interface within the main nacelle unit; and
coupling the mounting interface of the crane base to the mounting pad of the base frame.

18. The method of claim 17, wherein moving the crane base from the stored position to the deployed position further comprises:
moving the crane base in an upward or downward direction in a first, vertical movement direction relative to the rotation axis (A1) of the wind turbine nacelle; and/or
moving the crane base laterally in a frontward or backward direction and/or in a side-to-side direction in a second, horizontal movement direction relative to the rotation axis (A1) of the wind turbine nacelle to align the mounting interface of the crane base with the mounting pad of the base frame.

19. The method of claim 18, wherein moving the crane base includes simultaneously moving the crane base in the first, vertical movement direction and in the second, horizontal movement direction relative to the rotation axis (A1) of the wind turbine nacelle.

20. The method of claim 17, wherein the crane includes a yaw system and moving the crane base from the stored position to the deployed position further comprises:
operating the yaw system to rotate the crane base between the stored position and the deployed position.

21. The method of claim 17, further comprising:
hoisting the main nacelle unit to a top of the wind turbine tower; and
hoisting the service unit to the main nacelle unit with the crane base in the stored position.

22. The method of claim 17, further comprising:
attaching the service unit to the main nacelle unit such that the service unit is located alongside the main housing outer wall; and
hoisting the main nacelle unit having the service unit attached thereto to a top of the wind turbine tower.
